(19) United States
(12) Patent Application Publication
(10) Pub. No.: US 2005/0074621 A1
(43) Pub. Date: Apr. 7, 2005

(54) Moisture vapor barrier laminate

(76) Inventors: Tricia Susan Reighard, Loveland, OH (US); David Verd Reed, Blanchester, OH (US)

Correspondence Address: Melvin D. Fletcher;International Paper, 6285 Tri Ridge Boulevard, Loveland, OH, 45140, US

(21) Appl. No.: 10/676,550

(22) Filed: Oct. 1, 2003

(51) Int. Cl. B32B 27/06; B32B 27/36; B32B 23/08

(52) U.S. Cl. 428/511; 428/481; 428/483; 428/514

(57) ABSTRACT

A paperboard laminate comprising a paperboard substrate, having an interior surface and an exterior surface, a layer of high density polyethylene on the interior surface of the paperboard substrate, a tie layer interior to the high density polyethylene layer, a barrier layer interior to the high density polyethylene layer, a second tie layer interior to the barrier layer, and a polyolefin layer interior to the second tie layer. The laminate is useful for packaging dry food products such as ready-to-eat cereals, powdered drink mixes, baking goods, and non-food products such as dry laundry detergent, fertilizer pellets, and powdered air fresheners.

### BACKGROUND OF THE INVENTION

The present invention is a paperboard laminate comprising a paperboard substrate, having an interior surface and an exterior surface, a layer of high density polyethylene on the interior surface of the paperboard substrate, a tie layer interior to the high density polyethylene layer, a barrier layer interior to the high density polyethylene layer, a second tie layer interior to the barrier layer, and a polyolefin layer interior to the second tie layer. The laminate is useful for packaging dry food products such as ready-to-eat cereals, powdered drink mixes and baking goods, and non-food products such as dry laundry detergent, fertilizer pellets, and powdered air fresheners.

Moisture is a primary factor limiting packaged dry food and non-food shelf life. Moisture changes are especially limiting for a shelf life longer than one year. Typically, products requiring shelf life longer than one year are packaged in glass jars, metal cans or paperboard foil laminate packages. However, in the case of paperboard foil laminates, the foil is susceptible to cracking, particularly in the score areas during conversion into a package, is expensive, and difficult to recycle in many regions of the world. The laminate of the present invention has water vapor barrier to prevent moisture gain/loss and subsequent texture changes and mold growth, and excellent oxygen barrier to minimize, for example, lipid oxidation and the formation of rancid off-odors/flavor.

The laminate of the present invention is useful for paper cartons for food products and other dry products. Conventional paper cartons for food products and other dry products are constructed of one or more layers of paper and include a plastic liner. The plastic liner is a bag used to seal the product and maintain product freshness. From a manufacturing and packaging point of view, the inner liner adds cost to the packaging operation, therefore it is desirable to produce a package or carton not requiring a plastic inner liner bag.

The present invention also provides a heat sealable laminate material having a low moisture vapor permeability during filling and storage over a range of temperatures and relative humidity.

### SUMMARY OF THE INVENTION

The present invention is a paperboard laminate comprising a paperboard substrate, having an interior surface and an exterior surface, a layer of high density polyethylene on the interior surface of the paperboard substrate, a tie layer interior to the high density polyethylene layer, a barrier layer interior to the high density polyethylene layer, a second tie layer interior to the barrier layer, and a polyolefin layer interior to the second tie layer.

### BRIEF DESCRIPTION OF THE FIGURES

FIG. 1 is a cross-sectional view of the laminate of the present invention.

FIG. 2 is a graphic representation of % weight gain of dry, ready-to-eat cereal vs. days after filling for packages that were stored at 90° F. and 75% relative humidity.

FIG. 3 is a graphic representation of % weight gain of powdered creamer vs. days after filling for packages that were stored at 90° F. and 75% relative humidity.

FIG. 4 is a graphic representation of % weight gain of dry, ready-to-eat cereal vs. days after filling for packages that were stored at 90° F. and. 75% relative humidity.

### DETAILED DESCRIPTION OF THE INVENTION

The present invention is a paperboard laminate comprising a paperboard substrate, having an interior surface and an exterior surface, a layer of high density polyethylene on the interior surface of the paperboard substrate, a tie layer interior to the high density polyethylene layer, a barrier layer interior to the high density polyethylene layer, a second tie layer interior to the barrier layer, and a polyolefin layer interior to the second tie layer.

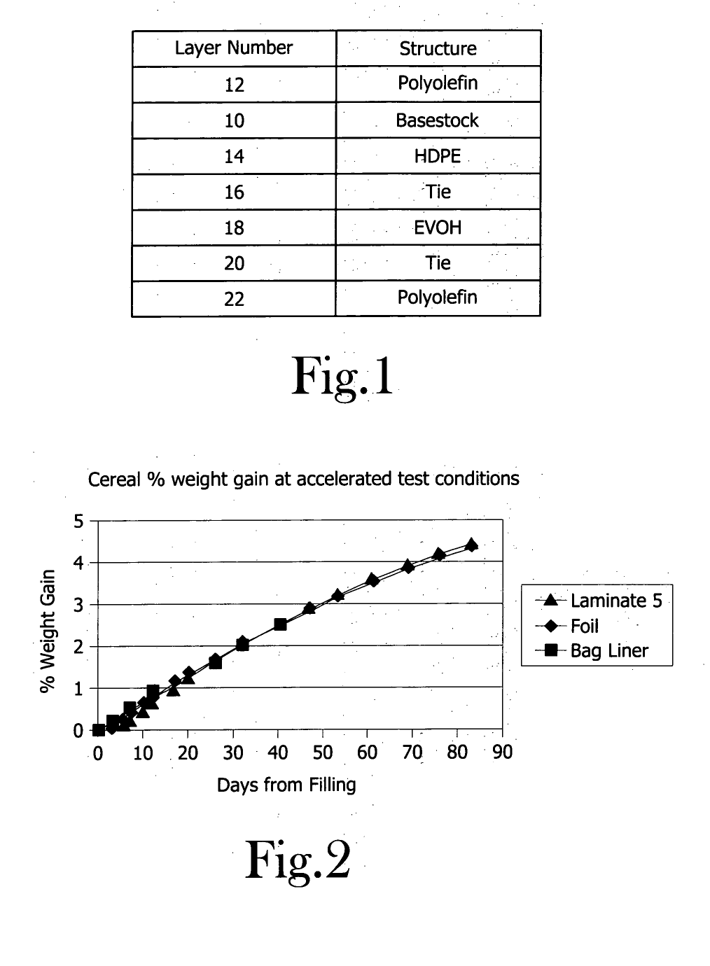

FIG. 1 shows a cross-sectional view of laminate 5 containing a paperboard substrate 10 of 100 to 300 lbs. per 3000 square feet onto which there is preferably applied on one side a coating of polyethylene polymer layer 12 such as low density polyethylene at a coating weight of 5 to 20 lbs. and preferably about 10 to 12 lbs. to provide the outer surface of the laminate. There may be applications in which layer 12 is not needed. The substrate 10 may be liquid packaging board, folding carton, cupstock, or even a bleached or unbleached Kraft liner board.

The inner surface of layer 14 there is applied a tie layer. 16 with a coat weight of 1 to 10 lbs., preferably about 1.5 to 5 lbs. Suitable adhesive tie layers are polyolefins, anhydride modified polyolefins, ethylene acrylic acid, ethylene methyl acrylic acid, ethylene vinyl acetates. Preferably the tie layer is based on, but not limited to, ethylene based copolymers modified with maleic anhydride functional groups.

The barrier layer 18 is applied interior to the high density polyethylene layer. Preferable layer 18 is a ethylene vinyl alcohol copolymer (EVOH) oxygen barrier and applied to the underside of the tie layer 16 and has a coating weight of 1 to 10 lbs. and preferably about 3 to 5 lbs. The EVOH material may contain 26 to 48 mole % ethylene. Layer 18 can also be, but is not limited to, oxygen scavenging EVOH material, EVOH nanocomposites, or blends of EVOH with polyolefins such as low density polyethylene. The EVOH layer 18 serves as a barrier to oxygen ingress. Another advantage is that EVOH is also a barrier to odors/aromas entering the carton and helps to prevent aroma/flavor scalping from the product. For products that do not require as much oxygen barrier, the EVOH could be replaced with a barrier layer selected from the group consisting of polyamides, polyethylene terephthalates, polyesters, polyvinyl alcohols, polyolefins, cyclic olefin copolymers, polycarbonates, liquid crystalline polymers and blends thereof, or blends of any of the foregoing with at least one member selected from the group consisting of desiccants, molecular sieves, and cyclodextrins.

A second tie layer 20 is applied to the underside of the layer 18. As with tie layer 16, the coating weight is typically 1 to 10 lbs. and preferably 1.5 to 5 lbs. Finally, a layer 22 of polyolefin is applied over the tie layer 20 and may form the product contact surface. The polyolefin coat weight can be 1 to 30 lbs. and preferably about 5 to 10 lbs. Acceptable polyolefins include, but are not limited to, low density polyethylene, high density polyethylene, linear low density polyethylene, polypropylene, metallocene, and blends thereof.

Referring to laminate 5 in FIG. 1, the polyolefin layer 12 is extrusion coated onto the substrate 10. The HDPE layer 14 is then deposited on the uncoated side of the substrate 10. The tie layer 16, EVOH layer 18, and tie layer 20 are applied as a coextrusion over the HDPE layer 14. The tie layer 20 is then overcoated with polyolefin layer 22 forming laminate 5. The laminate could also be produced as a five layer coextrusion consisting of HDPE layer 14, tie layer 16, EVOH layer 18, tie layer 20, and polyolefin layer 22. While these are two methods of forming laminate 5, other methods can be employed to result in the same final structure.

A laminate structure was prepared suitable for use in the packaging of dry food and non-food products. All weights are expressed in pounds per 3000 square feet.

The following examples are provided to illustrate the present invention. The examples are not intended to limit the claims herein.

### EXAMPLE 1

A moisture vapor barrier laminate consistent with the format of laminate 5 was produced using 30 lbs. HDPE in layer 14, 4 lbs. EVOH in layer 18, and 10 lbs. LDPE in layer 22. The resulting flat sample was tested for water vapor transmission rate (WVTR) in comparison to standard cereal bag stock consisting of a 2 mil thick coextruded film of HDPE and ethylene vinyl acetate (EVA). Results for WVTR testing at 38° C./90% RH are shown in TABLE 1.

TABLE 1

| Sample | WVTR (grams/100 in²/day) |
|---|---|
| Laminate | 0.064 |
| Bag stock | 0.073 |

### EXAMPLE 2

The laminate defined in Example. 1 was converted into skived, liter gable top cartons. Foil lined, nonskived, liter gable top cartons were also produced. Standard cereal bag stock in the form of a pouch was used for comparison. The cartons and pouches were filled with dry, ready-to-eat cereal and stored at accelerated test conditions of 90° F. and 75% relative humidity. One week at these storage conditions is believed to simulate one month of ambient storage. The packages were weighed periodically throughout the 6 week test. The percent weight gain of the cereal over time is plotted in FIG. 2. Cereal in the three packages performed equivalently across the test period.

### EXAMPLE 3

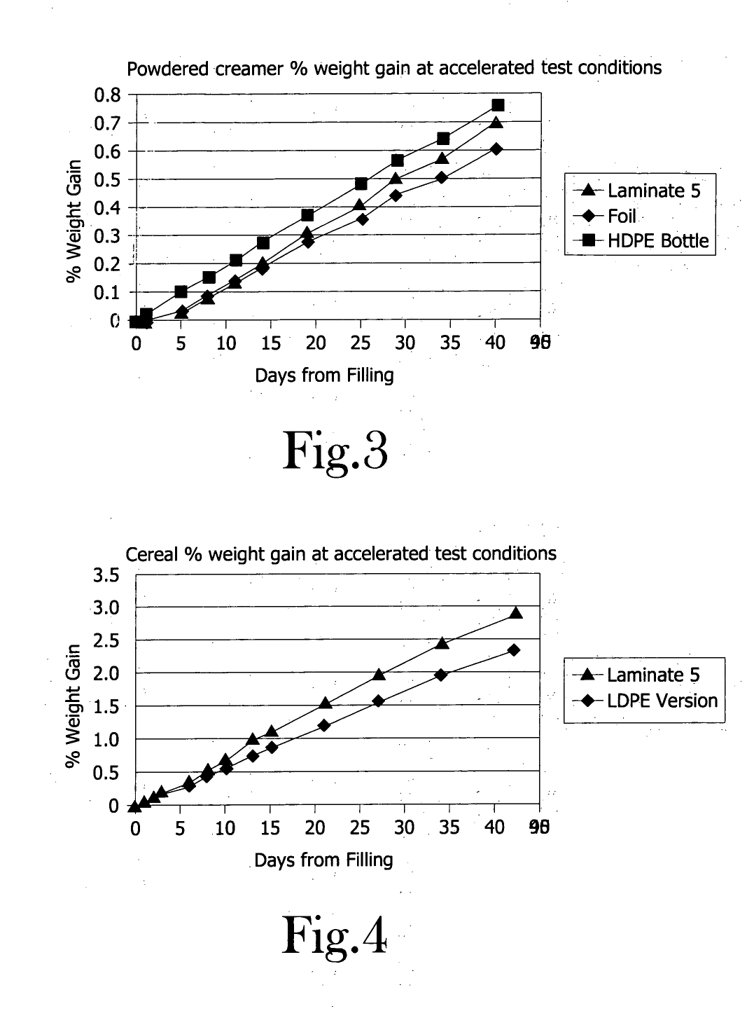

The same cartons used in Example 2 were also filled with powdered coffee creamer and compared to a commercial HDPE bottle at accelerated test conditions. Percent weight gain of the creamer over time is shown in FIG. 3.

The food moisture in the three packages at day 40, measured by recording the difference in weight before and after drying at 105° C. for 15 minutes, was 4.3 weight % for the laminate 5 and foil cartons and 4.5 weight % for the HDPE bottle.

### EXAMPLE 4

A second laminate (“LDPE Version”) similar in format to laminate 5 used in the above Examples was produced using 30 lbs. LDPE in layer 14, 4 lbs. EVOH in layer 18, and 10 lbs. LDPE in layer 22 and converted into skived liter gable top cartons. The cartons were filled with a dry, ready-to-eat cereal and stored at the same accelerated test conditions used in Examples 2 and 3. Percent weight gain of the cereal over time is plotted in FIG. 4. After 42 days, percent moisture weight gain was 24% less in laminate 5 than in the LDPE Version laminate.

1. A paperboard laminate comprising:
a paperboard substrate, having an interior surface and an exterior surface;
a layer of high density polyethylene on the interior surface of the paperboard substrate;
a tie layer interior to the high density polyethylene layer;
a barrier layer interior to the high density polyethylene layer;
a second tie layer interior to the barrier layer;
and a second polyolefin layer interior to the second tie layer.

2. The paperboard laminate according to claim 1, further comprising a layer of polyolefin on the exterior surface of the paperboard substrate.

3. The paperboard laminate according to claim 1, wherein the barrier layer is selected from the group consisting of polyamides, polyethylene terephthalates, polyesters, ethylene vinyl alcohol copolymers including oxygen scavenging EVOH, EVOH nanocomposites, and blends of EVOH with polyolefins, polyvinyl alcohols, polyolefins, cyclic olefin copolymers, polycarbonates, liquid crystalline polymers.

4. The paperboard laminate according to claim 3, wherein the barrier layer is blended with at least one material selected from the group consisting of desiccants, molecular sieves, and cyclodextrins.

5. The paperboard laminate according to claim 3, wherein the barrier layer is ethylene vinyl alcohol.

6. The paperboard laminate according to claim 1, wherein the polyolefin is polyethylene.

7. The paperboard laminate according to claim 1, wherein the second polyolefin layer is polyethylene and contacts the container contents.

8. The paperboard laminate according to claim 1, wherein the high density polyethylene has a density range of 0.94 g/cm³ to 0.96 g/cm³.

9. The paperboard laminate according to claim 1, wherein the tie layer is selected from the group consisting of anhydride modified polyolefins, ethylene acrylic acids, ethylene methyl acrylic acids, and ethylene vinyl acetates.

10. The paperboard laminate according to claim 9, wherein the tie layer is an ethylene based copolymer modified with maleic anhydride functional groups.

11. The paperboard laminate according to claim 9, wherein the tie layer is an ethylene vinyl acetate.

12. A container blank constructed from a laminated packaging material according to claim 1.

13. The paperboard laminate according to claim 12, wherein the blank is formed into a container wherein dry goods are packaged in the container.

14. A paperboard laminate comprising:
a paperboard substrate, having an interior surface and an exterior surface;
a layer of polyolefin on the exterior surface of the paperboard substrate;
a layer of high density polyethylene on the interior surface of the paperboard substrate;
a tie layer interior to the high density polyethylene layer;
an ethylene vinyl alcohol layer interior to the high density polyethylene layer;
a second tie layer interior to the barrier layer;
and a second polyolefin layer interior to the second tie layer.
